(19) United States
(12) Patent Application Publication
(10) Pub. No.: US 2024/0414453 A1
(43) Pub. Date: Dec. 12, 2024

(54) IMAGE SENSOR WITH TEMPERATURE SENSING PIXELS

(71) Applicant: ams-OSRAM AG, Premstaetten (AT)

(72) Inventors: Manuel GARCIA GONZALEZ JOSE, San Antonio de Benageber (ES); Rafael SERRANO-GOTARREDONA, Valencia (ES); Joel BERTOMEU MESTRE, Oliva, Valencia (ES)

(21) Appl. No.: 18/717,439

(22) PCT Filed: Oct. 6, 2022
(86) PCT No.: PCT/EP2022/077857

§ 371 Date: Jun. 7, 2024

(30) Foreign Application Priority Data
Dec. 9, 2021 (DE) 10 2021 214 017.3

(51) Int. Cl. H04N 25/77; H04N 25/78

(52) U.S. Cl. CPC H04N 25/77; H04N 25/78

(57) ABSTRACT

The present disclosure provides an image sensor with temperature sensing including a pixel array having a plurality of pixels, wherein at least one of the pixels includes a photodiode and is configured to be operated in a light sensing mode for sensing light radiation incident on the photodiode, and in a temperature sensing mode for sensing a temperature of the at least one pixel. The image sensor is configured so that, in the light sensing mode of the at least one pixel, a voltage across the photodiode caused by the light radiation incident on the photodiode is evaluated, and, in the temperature sensing mode of the at least one pixel, a current is forced through the photodiode and the voltage across the photodiode, caused by the current forced through the photodiode, is evaluated.

### CROSS-REFERENCE TO RELATED APPLICATIONS

This application is a 371 U.S. National Phase of PCT International Patent Application No. PCT/EP2022/077857, filed on Oct. 6, 2022, which claims priority from German Patent Application No. 10 2021 214 017.3, filed on Dec. 9, 2021, the disclosures of which are incorporated by reference herein in their entirety for all purposes.

### TECHNICAL FIELD

The disclosure relates to an image sensor, for example a large scale CMOS image sensor, with a temperature sensing function.

### BACKGROUND

Pixels in an image sensor, for example a CMOS image sensor, are sensitive to PVT (Process-Voltage-Temperature) variations. Regarding an image sensor, PVT variations produce changes in the fixed pattern noise (FPN), leakage and dark current, conversion gain and linearity.

Temperature variations across a sensor area can be caused by read-out circuitries placed on the top of a wafer of the image sensor or by any other heating source. The read-out circuitries consume a lot of power and thus produce a temperature gradient along the wafer or the sensor area. Furthermore, the temperature variations along the sensor area are caused by the self-heating of the wafer during operation of the image sensor.

In the case of large scale image sensors, the larger the temperature gradient observed across the sensor area, the larger the produced non-uniformity in the images provided by the image sensor. This is caused by the fact that the output signals provided by the image sensor are dependent on a gate-source voltage of a source-follower transistor of the pixels of the image sensor and the photodiode leakage current, which in turn depends on the temperature of the location of the pixel on the sensor area of the image sensor.

If the temperature of a pixel in a pixel array of an image sensor can be detected, the detected temperature can be used to calibrate the pixel or correct an output signal delivered by the pixel depending on the detected temperature. Due to the large temperature gradient across the pixel array, the sensing of the temperature should be performed within a pixel or close to a pixel under calibration or correction.

There is a desire to provide an image sensor with temperature sensing which allows the temperature of a pixel of the image sensor to be detected at different locations in the pixel area without reducing the resolution of the image sensor.

### SUMMARY

An embodiment of an image sensor with temperature sensing at pixel level with reduced pixel modification, and without losing the functionality of a pixel for sensing light radiation is provided.

The image sensor with temperature sensing includes a pixel array having a plurality of pixels, wherein at least one of the pixels includes a photodiode. The at least one of the pixels is configured to be operated in a light sensing mode for sensing light radiation incident on the photodiode, and in a temperature sensing mode for sensing a temperature of the at least one pixel.

The image sensor is configured so that, in the light sensing mode of the at least one pixel, a voltage across the photodiode caused by the light radiation incident on the photodiode is evaluated, and, in the temperature sensing mode of the at least one pixel, a current is forced through the photodiode and the voltage across the photodiode, caused by the current forced through the photodiode, is evaluated.

The described image sensor with temperature sensing allows performing temperature sensing at pixel level and without the pixel intended for temperature detection losing its functionality for sensing the light incident on the pixel. The temperature sensing functionality is integrated into the at least one pixel without losing the function of light sensing. In particular, the described approach of an image sensor with a temperature sensing functionality uses the photodiode voltage of the pixel for measuring the temperature of the pixel, wherein the functionality of the at least one pixel for sensing light is retained.

The complete pixel array can be built by sub-blocks of the pixel array which are stitched to form the complete pixel array. Each sub-block/pixel sub-array of the complete pixel array on a reticle can include one or several pixels for temperature sensing per sub-block being distributed over the sub-block so that the temperature can be sensed at different areas of the stitched sub-blocks of the pixel array.

According to an embodiment of the image sensor, the photodiode of the at least one pixel includes a first terminal and a second terminal. The at least one pixel includes a first controllable switching circuit for applying a supply current to the first terminal of the photodiode, and a second controllable switching circuit for applying a ground potential to the second terminal of the photodiode, when the at least one pixel is operated in the light sensing mode.

The first and second controllable switching circuit enable that the at least one pixel may be operated in a light sensing mode, in which the voltage across the photodiode depends on the light incident on the photodiode. In the light sensing mode, the first and second controllable switching circuit have to be operated in a closed/conducting state. The voltage across the photodiode can be read out and evaluated by an evaluation circuit for sensing the light radiation on the at least one pixel.

According to an embodiment, the image sensor includes a current supply line to provide the current to be forced through the photodiode of the at least one pixel. The at least one pixel includes a third controllable switching circuit for forcing the current through the photodiode. The third controllable switching circuit is arranged between the current supply line and the second terminal of the photodiode.

The third controllable switching circuit enables to couple the second terminal of the photodiode to the current supply line for forcing the current through the photodiode, when the at least one pixel is operated in the temperature sensing mode.

According to an embodiment of the image sensor, the at least one pixel includes a fourth controllable switching circuit for coupling the first terminal of the photodiode to the ground potential, when the at least one pixel is operated in the temperature sensing mode.

In the temperature sensing mode, the third and the fourth controllable switching circuit are operated in a closed/conducting state, and the first and second controllable switching circuit are operated in an open/non-conducting state so that the current can be forced through the photodiode, and a voltage across the photodiode can be detected for temperature sensing. On the other hand, in a light sensing mode, the third and fourth controllable switching circuits are operated in an open/non-conducting state for sensing light radiation incident on the photodiode of the at least one pixel.

According to an embodiment, the image sensor includes a voltage line for reading out the voltage across the photodiode, and a source follower transistor. The source follower transistor is connected to the voltage line, and has a control terminal being connected to the first terminal of the photodiode.

The source follower transistor allows reading out the voltage across the photodiode on the voltage line in the light sensing mode of the at least one pixel.

According to an embodiment of the image sensor, the pixel array includes at least one second pixel. The at least one second pixel includes a second photodiode. The at least one second pixel is configured to be operated in a light sensing mode for sensing light radiation incident on the second photodiode and in a temperature sensing mode for sensing the temperature of the at least one pixel.

The at least one second pixel may be used for reading out the voltage across the photodiode of the at least one pixel in the temperature sensing mode of the at least one pixel, wherein the functionality of the at least one second pixel for sensing light is not affected.

According to an embodiment, the image sensor includes a second voltage line for reading out the voltage across the second photodiode. The at least one second pixel includes a fifth controllable switching circuit for coupling the second terminal of the photodiode of the at least one pixel to the second voltage line.

The fifth controllable switching circuit enables to read out the voltage across the photodiode of the at least one pixel via a Kelvin connection between the second terminal of the photodiode of the at least one pixel and the second voltage line. On the other hand, in the open/non-conducting state of the fifth controllable switching circuit, the at least one second pixel can be operated in the light sensing mode for sensing light incident on the second photodiode.

According to an embodiment of the image sensor, the pixel array includes at least one third pixel. The at least one third pixel includes a third photodiode. The at least one third pixel is configured to be operated in a light sensing mode for sensing light radiation incident on the third photodiode, and in a ground sensing mode for sensing a potential at the first terminal of the photodiode of the at least one pixel.

The ground resistance at the second terminal of the photodiode of the at least one pixel has an essential impact in the temperature error during the temperature sensing, which results in an offset which can be compensated during wafer sorting. The at least one third pixel enables sensing the ground potential at the first terminal of the photodiode without losing the functionality of the at least one third pixel for sensing light radiation incident on the third photodiode.

According to an embodiment, the image sensor includes a third voltage line for reading out the voltage across the third photodiode. The at least one third pixel includes a sixth controllable switching circuit for coupling the first terminal of the photodiode to the third voltage line.

The sixth controllable switching circuit can be operated in a closed/conducting state to read out the ground potential at the first terminal of the photodiode of the at least one pixel in the temperature sensing mode to determine the ground resistance at the first terminal of the photodiode of the at least one pixel, and thus the impact of the ground resistance in the temperature error.

According to a possible embodiment of the image sensor, the pixel array may include at least one fourth pixel. The at least one fourth pixel includes a fourth photodiode. The at least one fourth pixel is configured to be operated in a light sensing mode for sensing light radiation incident on the fourth photodiode and in a temperature sensing mode for sensing a temperature of the at least one fourth pixel. The image sensor is configured so that, in the light sensing mode, a voltage across the fourth photodiode caused by the light radiation incident on the fourth photodiode is evaluated. The image sensor is further configured so that, in the temperature sensing mode, the current is forced through the fourth photodiode and the voltage across a fourth photodiode caused by the current forced through the fourth photodiode is evaluated.

The at least one fourth pixel can thus be used for sensing light radiation incident on the fourth photodiode, and for sensing the temperature of the at least one fourth pixel. This configuration enables the measurement of the photodiode voltage across the fourth photodiode combined with the measurement of the photodiode voltage across the first photodiode.

According to an embodiment of the image sensor, the fourth photodiode includes a first terminal and a second terminal. The at least one fourth pixel includes a seventh controllable switching circuit for applying a supply current to the first terminal of the fourth photodiode, and an eight controllable switching circuit for applying a ground potential to the second terminal of a fourth photodiode, when the at least one fourth pixel is operated in the light sensing mode.

The seventh and eighth controllable switching circuits enable to operate the fourth photodiode in the light sensing mode by applying the supply current to the first terminal of the fourth photodiode and applying the ground potential to the second terminal of the fourth photodiode, and measuring the voltage across the fourth photodiode. The voltage determined across the fourth photodiode depends on the light incident on the fourth photodiode, and can be read-out to be evaluated by an evaluation circuit for sensing the temperature of the at least one fourth pixel.

According to an embodiment of the image sensor, the at least one fourth pixel includes a ninth controllable switching circuit for forcing the current through the fourth photodiode. The ninth controllable switching circuit is arranged between the current supply line and the second terminal of the fourth photodiode.

The ninth controllable switching circuit enables to couple the second terminal of the fourth photodiode to the current supply line for forcing the current through the fourth photodiode, when the at least one fourth pixel is operated in the temperature sensing mode. Moreover, the ninth controllable switching circuit enables to couple the second terminal of the fourth photodiode to the current supply line for reading out the voltage across the fourth photodiode during the temperature sensing mode.

According to an embodiment of the image sensor, the at least one fourth pixel includes a tenth controllable switching circuit for coupling the first terminal of the fourth photodiode to the ground potential, when the at least one fourth pixel is operated in the temperature sensing mode.

The tenth controllable switching circuit thus allows to provide a current path for forcing the current through the fourth photodiode in the temperature sensing mode by operating the tenth controllable switching circuit in the closed/conducting state.

According to an embodiment of the image sensor, the second terminal of the fourth photodiode is coupled to the second voltage line for reading out the voltage across the fourth photodiode.

The second terminal of the fourth photodiode may be coupled to the second voltage line via the third controllable switching circuit, the fifth controllable switching circuit and the ninth controllable switching circuit which enables a Kelvin connection for reading out the voltage across the fourth photodiode in the temperature sensing mode of the at least one fourth pixel.

The provision of the additional controllable switching circuits in the at least one pixel, the at least one second pixel, the at least one third pixel and the at least one fourth pixel allows to operate each of the pixels in a light sensing mode or a temperature sensing mode, and requires only a minor modification of the pixels which does not affect the functionality of the pixels for sensing a light radiation on the photodiode of the respective pixels.

According to an embodiment, the image sensor includes a control circuitry for addressing each of the at least one pixel and the at least one second pixel and the at least one third pixel and the at least one fourth pixel to be operated in the temperature sensing mode. The control circuitry is configured as an asynchronous logic based on a handshake mechanism.

Large scale CMOS image sensors require stitching for building the whole sensor, thus some lines for controlling the operation of the pixels of the pixel array need to be connected from one stitched block to the next one. In order to control the temperature measurement, there will be extra control lines which need to be stitched. In order to reduce the number of control lines, which can degrade the final yield, the control circuitry provides a reduced logic for addressing each single temperature sensor. In order not to reduce the pixel fill factor, the extra logic can be placed spread in more than one pixel.

Additional features and advantages of the image sensor for temperature sensing are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows a wafer including an image sensor and a reticle layout for manufacturing the image sensor;

FIG. 2 shows an embodiment of modified pixels of a pixel array of an image sensor for temperature sensing;

FIG. 3 shows a reticle layout for manufacturing an image sensor with temperature sensing;

FIG. 4 illustrates the generation of control signals for controlling pixels of a pixel array in a temperature sensing mode by a control circuit; and

FIG. 5 illustrates the connection of a read-out/control circuitry to a stitched pixel sub-array for controlling a temperature sensing mode of pixels of the pixel sub-array.

### DETAILED DESCRIPTION

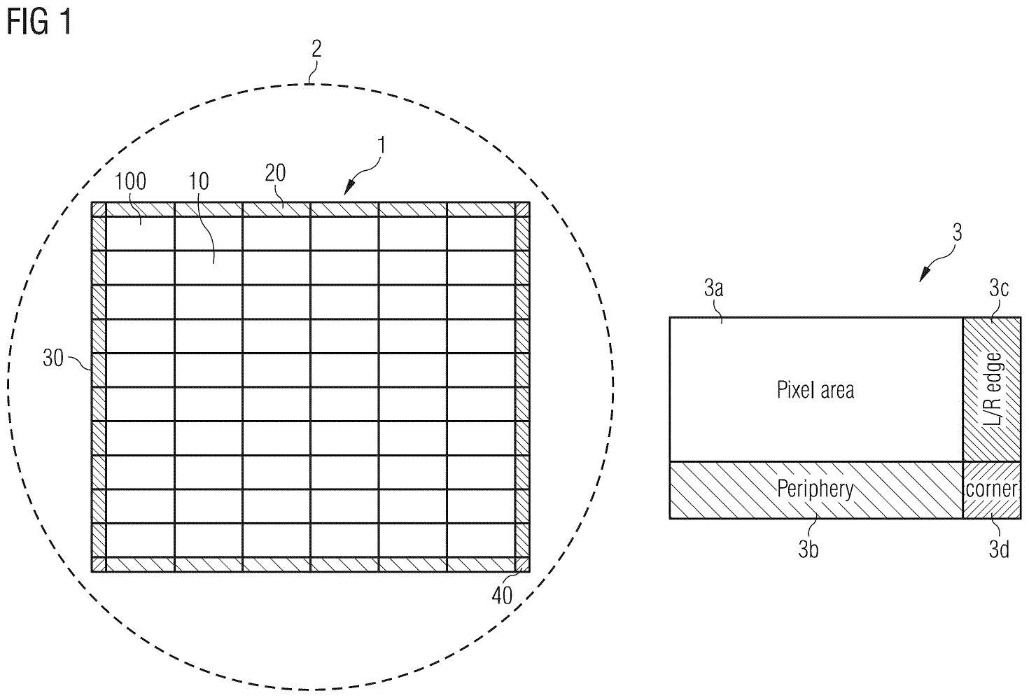

A large scale CMOS image sensor usually requires stitching of a plurality of pixel sub-arrays for manufacturing the complete pixel array of the image sensor. FIG. 1 shows an image sensor 1 comprising a pixel array 10 including pixels 100 for light sensing. Each pixel 100 includes a photodiode to convert incident light in an electrical signal. The electrical signal/photodiode voltage can be read out on a voltage line via a selection transistor coupled to a source follower transistor having a gate node that is coupled to a terminal of the photodiode.

The image sensor 1 is manufactured on a wafer 2, for example a CMOS wafer, by a reticle 3. The layout of the reticle 3 includes a pixel sub-array 3a for manufacturing a pixel array 10 of the image sensor, a periphery area 3b for manufacturing a periphery 20 of the image sensor, a left/right edge area 3c for manufacturing the left/right edge 30 of the image sensor, and a corner area 3d for manufacturing the corner zones 40 of the image sensor 1.

The pixels 100 in the pixel array 10 are sensitive to PVT variations which produce changes in the fixed pattern noise (FPN), leakage and dark current, conversion gain and linearity. A large temperature gradient across the sensor area is caused by the self-heating of the pixel array, and the power consumption of read-out/control circuitries placed in the periphery 20 or the left/right edges 30 of the image sensor. In order to provide a calibration of the pixels or a correction of the output signals of the pixels influenced by the temperature gradient across the pixel area, the sensing of the temperature must be performed within a pixel or close to the pixel under calibration or correction.

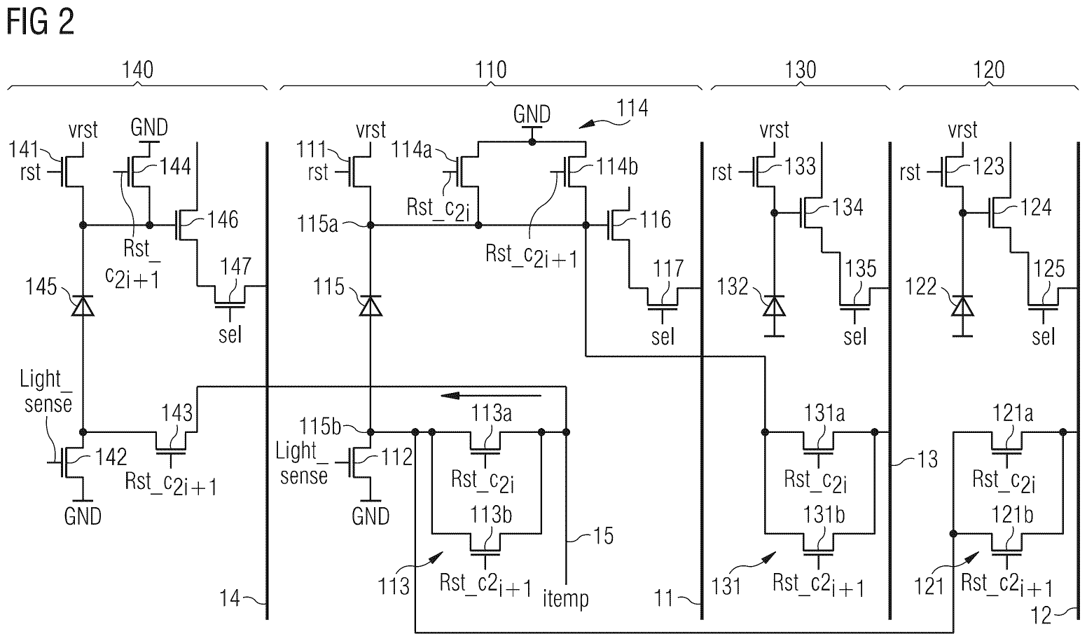

FIG. 2 shows a modified layout of pixels of an image sensor 1 for temperature sensing performed within a pixel. The image sensor 1 for temperature sensing may be built as shown in FIG. 1 and includes a pixel array 10 having a plurality of pixels such as pixels 100 configured only for light sensing, as described about and shown in FIG. 1. The image sensor 1 for temperature sensing includes additional pixels 110, 120, 130, 140 being configured for both of light sensing and temperature sensing.

Referring to FIG. 2, at least one of the pixels 110 includes a photodiode 115. The at least one of the pixels 110 is configured to be operated in a light sensing mode for sensing light radiation incident on the photodiode 115, and in a temperature sensing mode for sensing a temperature of the at least one pixel 110. The image sensor may further include an evaluation circuit for determining the light radiation on the at least one pixel and for determining the temperature of the at least one pixel.

The image sensor 1 is configured so that, in the light sensing mode of the at least one pixel 110, a voltage across the photodiode 115, caused by the light radiation incident on the photodiode 115, is evaluated. The image sensor 1 is further configured so that, in the temperature sensing mode of the at least one pixel 110, a current itemp is forced through the photodiode 115, and the voltage across the photodiode 115 that is caused by the current forced through the photodiode 115 is evaluated.

The photodiode 115 includes a terminal 115a and a terminal 115b. The at least one pixel 110 includes a controllable switching circuit 111 for coupling terminal 115a to a supply potential vrst for applying a supply current to the terminal 115a of the photodiode 115, and a controllable switching circuit 112 for applying a ground potential GND to the terminal 115b of the photodiode 115, when the at least one pixel 110 is operated in the light sensing mode. In the light sensing mode, the controllable switching circuit 111 and 112 are operated in a closed/conducting state which is controlled by a control signal rst for the controllable switching circuit 111 and a control signal light sense for the controllable switching circuit 112.

The image sensor 1 includes a current supply line 15 to provide the current itemp to be forced through the photodiode 115. The at least one pixel 110 includes a controllable switching circuit 113 for forcing the current itemp through the photodiode 115. The controllable switching circuit 113 is arranged between the current supply line 15 and the terminal 115b of the photodiode 115.

The controllable switching circuit 113 is configured for coupling the terminal 115b of the photodiode 115 to the current supply line 15 for forcing the current itemp through the photodiode 115, when the at least one pixel 110 is operated in the temperature sensing mode. The controllable switching circuit 113 may include a controllable switch 113a and a controllable switch 113b being connected in parallel between the current supply line 15 and the terminal 115b of the photodiode 115. The controllable switch 113a is controlled by a control signal Rst_c2i and the controllable switch 113b is controlled by a control signal Rst_c2i+1.

The at least one pixel 110 includes a controllable switching circuit 114 for coupling the terminal 115a of the photodiode 115 to the ground potential GND, when the at least one pixel 110 is operated in the temperature sensing mode. The controllable switching circuit 114 may include a controllable switch 114a and a controllable switch 114b being connected in parallel between a terminal to apply the ground potential GND and the terminal 115a of the photodiode 115. The controllable switch 114a is controlled by the control signal Rst_c2i, and the controllable switch 115b is controlled by the controlled signal Rst_c2i+1.

The image sensor 1 includes a voltage line 11 for reading out the voltage across the photodiode 115. The image sensor 1 further includes a driver/source follower transistor 116 being connected to the voltage line 11 via a selection transistor 117 that is controlled by a control signal sel. The source follower transistor 116 has a control/gate terminal being connected to the terminal 115a of the photodiode 115. The source follower transistor 116 is configured for reading out the voltage across the photodiode 115 in the light sensing mode of the at least one pixel 110.

The pixel array 10 includes at least one second pixel 120 that includes a photodiode 122. The at least one second pixel 120 is configured to be operated in light sensing mode for sensing light radiation incident on the photodiode 122, and in a temperature sensing mode for sensing the temperature of the at least one pixel 110.

The image sensor 1 includes a voltage line 12 for reading out the voltage across the photodiode 122 in the light sensing mode of the at least one pixel 120. The at least one pixel 120 includes a controllable switching circuit 121 for coupling the terminal 115b of the photodiode 115 to the voltage line 12. The controllable switching circuit 121 may include a controllable switch 121a and a controllable switch 121b being connected in parallel between the terminal 115b of the photodiode 115a and the voltage line 12. The controllable switch 121a is controlled by the control signal Rst_c2i, and the controllable switch 121b is controlled by the control signal Rst_c2i+1.

For light sensing, the at least one pixel 120 includes a controllable switching circuit 123 to couple the photodiode 122 to the supply potential vrst and providing a supply current through the photodiode 122, and a driver/source follower transistor 124 which is coupled via a selection transistor 125 to voltage line 12. The selection transistor is controlled by the control signal sel.

The pixel array 10 further includes at least one pixel 130 that includes a photodiode 132. The at least one pixel 130 is configured to be operated in a light sensing mode for sensing light radiation incident on the photodiode 132, and in a ground sensing mode for sensing a (ground) potential at the terminal 115a of the photodiode 115. The image sensor 1 includes a voltage line 13 for reading out the voltage across the photodiode 132.

The at least one pixel 130 includes a controllable switching circuit 131 for coupling the terminal 115a of the photodiode 115 to the voltage line 13. The controllable switching circuit 131 includes a controllable switch 131a being controlled by the control signal Rst_c2i, and being connected in parallel to a controllable switch 131b being controlled by the control signal Rst_c2i+1. The controllable switching circuit 131 is configured for sensing the (ground) potential of the terminal 115a of the photodiode 115 at the voltage line 13.

For light sensing, the at least one pixel 130 includes a controllable switch 133 being controlled by the control signal rst to couple the photodiode 132 to a supply potential vrst for providing a supply current through the photodiode 132. The voltage across the photodiode 132, when operated in the light sensing mode, can be read out via a driver/source follower transistor 134 which is coupled via selection transistor 135 to voltage line 13. Selection transistor 135 is controlled by control signal sel.

According to a possible embodiment, the pixel array 10 may further include at least one pixel 140 which includes a photodiode 145. The at least one pixel 140 is configured to be operated in a light sensing mode for sensing light radiation incident on the photodiode 145 and in a temperature sensing mode for sensing a temperature of the at least one pixel 140. The image sensor 1 is configured so that, in the light sensing mode, the voltage across the photodiode 145 caused by the light radiation incident on the photodiode 145 is evaluated, and, in the temperature sensing mode, the current itemp is forced through the photodiode 145, and the voltage across the photodiode 145, caused by the current itemp forced through the photodiode 145, is evaluated.

The photodiode 145 includes a terminal 145a and a terminal 145b. The at least one pixel 140 includes a controllable switching circuit 141 for coupling the terminal 145a of photodiode 145 to the supply potential vrst to provide a supply current through the photodiode 145, and a controllable switching circuit 142 for applying a ground potential to the terminal 145b of the photodiode 145, when the at least one pixel 140 is operated in the light sensing mode. The controllable switching circuit 141 is controlled by the control signal rst, and the controllable switching circuit 142 is controlled by the control signal light sense.

When operated in the light sensing mode, the voltage across the photodiode 145 can be read out via a driver/source follower transistor 146 which is coupled via a selection transistor 147 to voltage line 14. Selection transistor 147 is controlled by control signal sel.

The at least one pixel 140 further includes a controllable switching circuit 143 for forcing the current itemp through the photodiode 145. The controllable switching circuit 143 is arranged between the current supply line 15 and the terminal 145b of the photodiode 145. The controllable switching circuit 143 is configured for coupling the terminal 145b of the photodiode 145 to the current supply line 15 for forcing the current itemp through the photodiode 145, when the at least one pixel 140 is operated in the temperature sensing mode. The controllable switching circuit 143 is controlled by the control signal Rst_c2i+1.

The at least one pixel 140 includes a controllable switching circuit 144 for coupling the terminal 145a of the photodiode 145 to the ground potential GND, when the at least one pixel 140 is operated in the temperature sensing mode. The controllable switching circuit 144 is controlled by the control signal Rst_c2i+1.

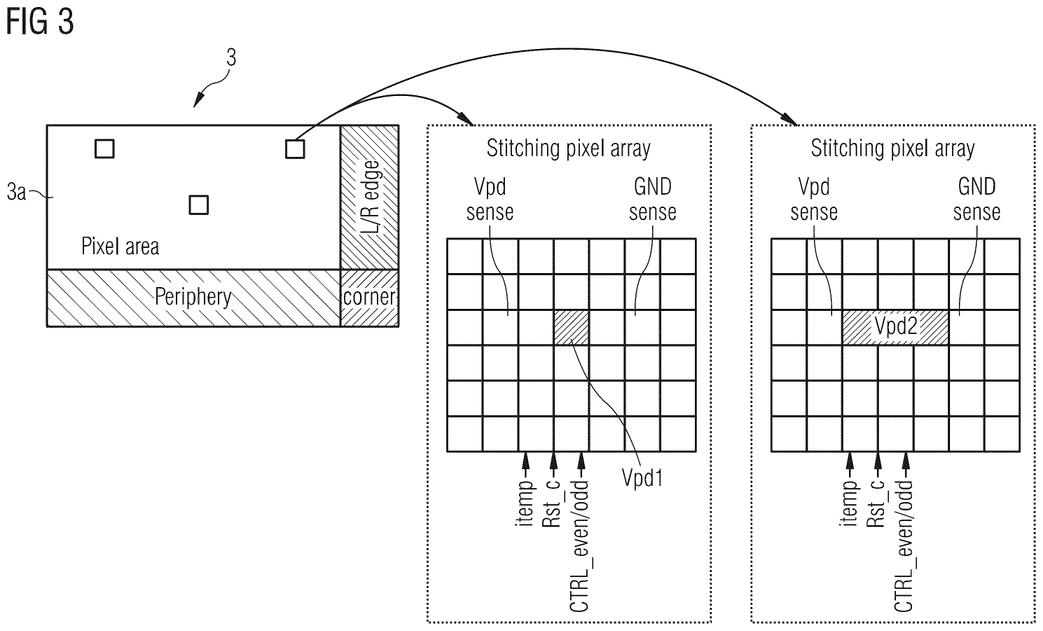

The described approach allows to provide distributed temperature sensors in the pixel array of large scale CMOS sensors. For this purpose, the reticle 3 used for building the image sensor by stitching pixel sub-arrays 3a has several modified pixels at certain locations distributed in the sub-pixel array 3a, as shown in FIG. 3. The pixel sub-array 3a includes modified pixels 110, 120, 130 and 140 at particular locations. The described approach thus allows the usage of distributed temperature sensors inside the pixel array 10 of a large scale image sensor 1.

The temperature sensing is carried out by measuring the voltage across the photodiode 115, 145 when forcing the current itemp through the photodiodes 115, 145 by operating the controllable switching circuits 113, 114 or 143, 144 in a closed/conducting state, and operating the controllable switching circuits 111, 112 or 141, 142 in an open/non-conducting state. The temperature sensing is carried out by measuring the photodiode voltage when forcing a current through the photodiode under two different conditions/measurements.

In the first condition/measurement of the temperature sensing mode illustrated in the left stitching pixel array of FIG. 3, the controllable switch 113a and the controllable switch 114a of a modified pixel 110 in a row of the pixel array are operated in the closed/conducting state so that the current itemp is forced through the photodiode 115. A voltage Vpd1 across the photodiode 115 is measured either at the current supply line 15, or via a Kelvin connection at the voltage supply line 12 by operating the controllable switch 121a in a closed/conducting state. The photodiode voltage Vpd1 is evaluated by an evaluation circuit of the image sensor.

In the second measurement/condition of the temperature sensing mode, there is the possibility to either add more photodiodes of the same row of the pixel array in parallel with a forced fixed current through the photodiodes, or having the same amount or number of photodiodes in the row of the pixel array and sweep the forced current.

For example, in the second measurement/condition illustrated in the right stitching pixel array of FIG. 3, the photodiode 115 and the photodiode 145 of the modified pixels 110 and 140 of the same row may be added in parallel by operating the controllable switch 113b and the controllable switch 143 in the closed/conducting state. The controllable switches 114b and 144 are operated in the conducting state.

According to a first possibility, the voltage Vpd2 across the photodiodes 115 and 145 of the same row of the pixel array can be measured during the second measurement at the current supply line 15 and evaluated by an evaluation circuit. According to a second possibility, the voltage Vpd2 across the photodiode 115 and 145 of the same row of the pixel array can be measured by the evaluation circuit via the Kelvin connection at the voltage line 12.

As explained above, the provision of the at least one fourth pixel in the pixel array to add two or more photodiodes of various pixels in parallel and measuring the voltage across the photodiodes on supply current line 15 or voltage line 12 is just one possible option for performing the second measurement. Another option for performing the second measurement is measuring the voltage across photodiode 115 during the second measurement without the need of adding the at least one fourth pixel 140 to the pixel array by supplying the photodiode 115 during the second measurement of the photodiode voltage with a different current than during the first measurement. That means performing the second measurement by having the same amount or number of photodiodes, for example using only photodiode 115, and sweep, i.e. change, the value of the forced current itemp through the photodiode 115.

The temperature is measured using either directly the photodiode voltage, or a buffered voltage at the pixel column output. The temperature is evaluated in the evaluation circuit by evaluating the difference between photodiode voltage Vpd1 measured under the first condition/during the first measurement and photodiode voltage Vpd2 measured under the second condition/during the second measurement:

$$Δ V pd = V pd 1 - V pd 2 = \frac{k \cdot T}{q} * ln ( N )$$

The factor N in the equation can be set by increasing the number of photodiodes of the pixels connected together, or by changing the value of the current itemp forced through only the photodiode of one pixel. If the temperature is measured by increasing the number of photodiodes connected together, the photodiodes have to be matched so that the current is equally distributed. If the temperature measurement is performed by changing the value of the current itemp forced through a photodiode, the current sources to provide the current to be forced through the photodiode have to be matched, for example by using the Dynamic Element Matching (DEM) technique.

The temperature Temp is proportional to the term

$$Temp ∝ \frac{α \cdot ΔV pd}{α \cdot ΔV pd + V pd}$$

where α is an amplification factor.

The described approach of an image sensor with temperature sensing also enables the measurement of the gain of the source follower transistor of a pixel by forcing a voltage to the gate node of the source follower transistor via controllable switching circuit 131, and measuring the output current of the source follower transistor at the voltage line coupled to the pixel.

The described pixel modification, as illustrated in FIG. 2 for the at least one pixel 110, 120, 130, 140, allows the temperature sensing in the at least one pixel 110 and/or the at least one pixel 140 without losing the functionality of the at least one pixel 110, 120, 130, 140 for sensing light.

The described approach for temperature sensing is based on the usage of the photodiode voltage for measuring the temperature at a location of a pixel of the pixel array of the image sensor or at different areas of a stitched block by adding a reduced number of controllable switching circuits in the certain pixels and not losing optical functionality/performance of light sensing. The controllable switching circuits may be realized by transistors. The presented modification of pixel architecture avoids the usage of logic gates and shows different alternatives for the temperature measurement and source follower (SF) characterization.

A large scale CMOS image sensor requires a stitching technique for building the whole sensor, thus some lines for routing control signals need to be connected from one stitched block to the next. In order to address the pixels by control signals CTRL_odd, CTRL even and to control the temperature measurement by control signals Rst_C₂ᵢ₋₁, Rst_C₂ᵢ, Rst_C₂ᵢ₊₁, . . . , there will be extra control lines which need to be stitched. In order to reduce the number of control lines, which can degrade the final yield, the described approach uses a reduced number of temperature sensors per stitched block, and a control circuitry having a reduced logic for addressing each single pixel/temperature sensor. In order to not reduce the pixel fill factor, the extra logic is placed spread in more than one pixel.

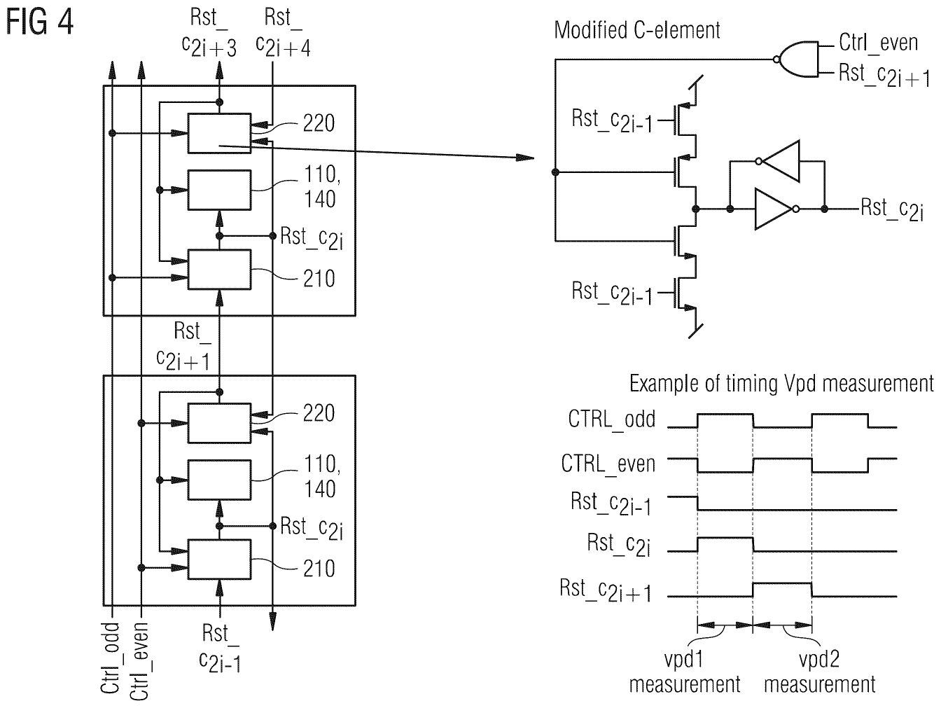

The described approach for generating the control signals Rst_cₓ by control circuits 210 and 220 of a stitched block for addressing each of the pixels 110, 120, 130 and 140 is illustrated in FIG. 4. The control circuits 210 and 220 of each stitched block are configured as an asynchronous logic based on a handshake mechanism. The addressing logic may be configured as a modified version of a so-called Muller chain built on weak-feedback C-elements, as illustrated in FIG. 4. This implementation requires only four signals to be transferred through the stitched blocks. FIG. 4 further shows the configuration of the modified C-element and a timing diagram of control signals for performing the Vpd1 and Vpd2 measurements.

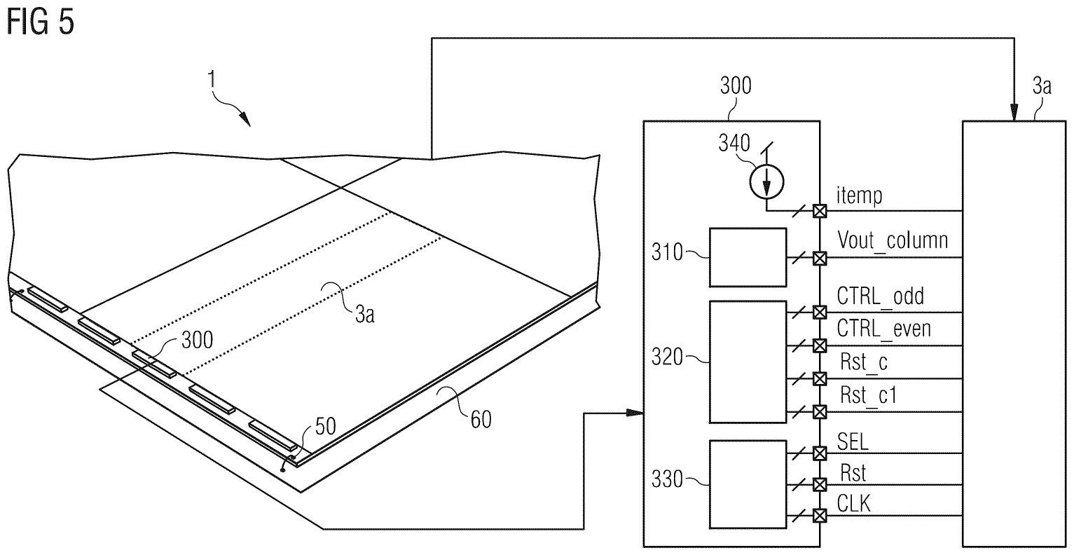

FIG. 5 illustrates the connection of a read-out/control circuitry 300 to a stitched pixel sub-array 3a for controlling a temperature sensing mode of pixels of the pixel sub-array. The read-out/control circuitry 300 is placed in the periphery of the image sensor and coupled by bond wires 50 to a carrier board 60.

The read-out/control circuitry 300 includes an evaluation circuit 310 for evaluating the voltage at the voltage lines of the pixel array, i.e. the voltage across the photodiodes of the pixels, and for determining the light radiation incident on the pixels 100, 110, 120, 130 and 140 and for determining the temperature of the at least one pixel 110 and 140 310. The read-out/control circuitry 300 further includes a control logic 320 for generating the control signals to be processed by the control circuits 210 and 220 to generate the control signals for controlling temperature sensing, and an image read-out control circuit 330 for generating the control signals to operate the pixels in the light sensing mode as well as a current source 340 for generating the current to be forced through a photodiode of a modified pixel, when operated in the temperature sensing mode.

The embodiments of the image sensor with temperature sensing disclosed herein have been discussed for the purpose of familiarizing the reader with novel aspects of the design of the image sensor. Although preferred embodiments have been shown and described, many changes, modifications, equivalents and substitutions of the disclosed concepts may be made by one having skill in the art without unnecessarily departing from the scope of the claims.

In particular, the design of the image sensor with temperature sensing is not limited to the disclosed embodiments, and gives examples of many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

### REFERENCES

1 image sensor
2 wafer
3 reticle
3a pixel sub-array
3b periphery area
3c left/right edge area
3d corner area
10 pixel array
20 periphery
30 left/right edge
40 corner
50 bond wire
60 carrier board
100 pixel
11-14 voltage line
15 current supply line
110, 120, 130, 140 modified pixels for temperature sensing
111, . . . , 114, 116, 117 controllable switching circuits
115 photodiode
121, 123, . . . , 125 controllable switching circuits
122 photodiode
131, 133, . . . , 135 controllable switching circuits
132 photodiode
141, . . . , 144, 146, 147 controllable switching circuits
145 photodiode
210, 220 control circuits
300 read-out/control circuitry
310 evaluation circuit
320 control logic
330 image read-out control circuit
340 current source

1. An image sensor with temperature sensing, comprising:
a pixel array having a plurality of pixels, wherein at least one of the pixels comprises a photodiode and is configured to be operated in a light sensing mode for sensing light radiation incident on the photodiode, and in a temperature sensing mode for sensing a temperature of the at least one pixel,
wherein the image sensor is configured so that, in the light sensing mode of the at least one pixel, a voltage across the photodiode caused by the light radiation incident on the photodiode is evaluated, and, in the temperature sensing mode of the at least one pixel, a current is forced through the photodiode and the voltage across the photodiode, caused by the current forced through the photodiode, is evaluated.

2. The image sensor of claim 1,
wherein the photodiode comprises a first terminal and a second terminal,
wherein the at least one pixel comprises a first controllable switching circuit for applying a supply current to the first terminal of the photodiode, and a second controllable switching circuit for applying a ground potential to the second terminal of the photodiode, when the at least one pixel is operated in the light sensing mode.

3. The image sensor of claim 2, further comprising:
a current supply line to provide the current to be forced through the photodiode,
wherein the at least one pixel comprises a third controllable switching circuit for forcing the current through the photodiode,
wherein the third controllable switching circuit is arranged between the current supply line and the second terminal of the photodiode.

4. The image sensor of claim 3,
wherein the at least one pixel comprises a fourth controllable switching circuit for coupling the first terminal of the photodiode to the ground potential, when the at least one pixel is operated in the temperature sensing mode.

5. The image sensor of claim 2, further comprising:
a voltage line for reading out the voltage across the photodiode,
a source follower transistor being connected to the voltage line,
wherein the source follower transistor has a control terminal being connected to the first terminal of the photodiode.

6. The image sensor of claim 2,
wherein the pixel array comprises at least one second pixel,
wherein the at least one second pixel comprises a second photodiode,
wherein the at least one second pixel is configured to be operated in a light sensing mode for sensing light radiation incident on the second photodiode and in a temperature sensing mode for sensing the temperature of the at least one pixel.

7. The image sensor of claim 6, further comprising:
a second voltage line for reading out the voltage across the second photodiode,
wherein the at least one second pixel comprises a fifth controllable switching circuit for coupling the second terminal of the photodiode to the second voltage line.

8. The image sensor of claim 2,
wherein the pixel array comprises at least one third pixel,
wherein the at least one third pixel comprises a third photodiode,
wherein the at least one third pixel is configured to be operated in a light sensing mode for sensing light radiation incident on the third photodiode, and in a ground sensing mode for sensing a potential at the first terminal of the photodiode.

9. The image sensor of claim 6, further comprising:
a third voltage line for reading out the voltage across the third photodiode,
wherein the at least one third pixel comprises a sixth controllable switching circuit for coupling the first terminal of the photodiode to the third voltage line.

10. The image sensor of claim 1,
wherein the pixel array comprises at least one fourth pixel,
wherein the at least one fourth pixel comprises a fourth photodiode,
wherein the at least one fourth pixel is configured to be operated in a light sensing mode for sensing light radiation incident on the fourth photodiode and in a temperature sensing mode for sensing a temperature of the at least one fourth pixel,
wherein the image sensor is configured so that, in the light sensing mode, a voltage across the fourth photodiode caused by the light radiation incident on the fourth photodiode is evaluated, and, in the temperature sensing mode, the current is forced through the fourth photodiode and the voltage across the fourth photodiode, caused by the current forced through the fourth photodiode, is evaluated.

11. The image sensor of claim 10,
wherein the fourth photodiode comprises a first terminal and a second terminal,
wherein the at least one fourth pixel comprises a seventh controllable switching circuit for applying a supply current to the first terminal of the fourth photodiode, and an eighth controllable switching circuit for applying a ground potential to the second terminal of the fourth photodiode, when the at least one fourth pixel is operated in the light sensing mode.

12. The image sensor of claim 1, comprising:
wherein the at least one fourth pixel comprises a ninth controllable switching circuit for forcing the current through the fourth photodiode,
wherein the ninth controllable switching circuit is arranged between the current supply line and the second terminal of the fourth photodiode.

13. The image sensor of claim 3,
wherein the at least one fourth pixel comprises a tenth controllable switching circuit for coupling the first terminal of the fourth photodiode to the ground potential, when the at least one fourth pixel is operated in the temperature sensing mode.

14. The image sensor of claim 10, further comprising a fourth voltage line for reading out the voltage across the fourth photodiode.

15. The image sensor of claim 1, further comprising:
a control circuitry for addressing each of the at least one pixel and the at least one second pixel and the at least one third pixel and the at least one fourth pixel to be operated in the temperature sensing mode,
wherein the control circuitry is configured as an asynchronous logic based on a hand shake mechanism.
